(19) United States
(12) Patent Application Publication
(10) Pub. No.: US 2007/0122151 A1
(43) Pub. Date: May 31, 2007

(54) BAND ALLOCATION CONTROL APPARATUS, BAND ALLOCATION CONTROL METHOD, AND BAND ALLOCATION CONTROL PROGRAM

(76) Inventor: Noritaka WATANABE, Tokyo (JP)

Correspondence Address: OSTROLENK FABER GERB & SOFFEN, 1180 AVENUE OF THE AMERICAS, NEW YORK, NY, 100368403, US

(21) Appl. No.: 11/555,408

(22) Filed: Nov. 1, 2006

(30) Foreign Application Priority Data
Nov. 2, 2005 (JP) 319597/2005

(51) Int. Cl. H04J 14/00

(52) U.S. Cl. 398/69

(57) ABSTRACT

A band allocation control apparatus to control bands to be allocated to a plurality of Optical Network Units (ONUs) includes a band allocating unit which sets an allocation band to be allocated to each ONU according to a ratio of a maximum band limit value of the ONU. The apparatus achieves band control guaranteeing impartiality between the service levels of ONUs.

### BACKGROUND OF THE INVENTION

1. Field of the Invention

The present invention relates to a band allocation control apparatus, a band allocation control method, and a band allocation control program for controlling bands to be allocated to a plurality of Optical Network Units (ONUs) constituting a Gigabit Ethernet (a registered trademark)—Passive Optical Network (GE-PON) system.

2. Description of the Related Art

Recently, there has been introduced a GE-PON in which Gigabit Ethernet is applied to communicate data using an Ethernet (a registered trademark) frame between a central station and each family. As shown in FIG. 1, the GE-PON includes an Optical Line Terminal (OLT) 104 disposed on the central station side and Optical Network Units (ONUs) 101 to 103 respectively disposed for communication terminals 121 to 123 on the subscriber side. Referring now to FIG. 1, description will be given of a system configuration using the GE-PON.

As can be seen from FIG. 1, the OLT 104 is connected via a one-core optical fiber cable 106 to an optical splitter 105 (a branch unit) in the GE-PON system. The optical splitter 105 is connected, on the uplink side thereof, via one-core optical fiber cables 107 to 109 to the ONUs 101 to 103, respectively. The ONUs 101 to 103 are respectively connected to the communication terminals 121 to 123 under a one-to-one correspondence established therebetween.

In the GE-PON system shown in FIG. 1, the OLT 104 conducts a scheduling operation to give grant of transmission to the ONUs 101 to 103. When the grant is received from the OLT 104, the ONU (101 to 103) transmits data to the OLT 104 according to the grant of transmission. It is therefore possible to avoid collision between data items 111 to 113 on the cable 106 between the OLT 104 and the optical splitter 105.

It is quite important to control the transmission grant bands of the respective ONUs 101 to 103 according to a Service Level Agreement (SLA) made between the communication enterprise side and the subscribers side, who uses the communication terminals 121 to 123, to thereby implement band control guaranteeing impartiality among the service levels of the terminals 121 to 123.

The impartiality between the service levels specifically is to provide the difference between bands for a high-speed service level and a low-speed service level.

The OLT 104 of the GE-PON system has an internal configuration including a Dynamic Bandwidth Allocation (DBA) Scheduler 301 as shown in FIG. 2. The DBA scheduler 301 executes processing to calculate bands to be allocated to the ONUs 101 to 103.

Each of the ONUs 101 to 103 of the GE-PON system is configured using a buffer remaining data value calculating section 302 and a data buffer 304 as shown in FIG. 2. The section 302 notifies a queue length request value to the OLT 104. The data buffer 304 stores data items received from the terminals 121 to 123 and then sends the data items to the OLT 104 according to a transmission grant queue length.

In the GE-PON system, as can be seen from FIG. 3, gate messages 201 to 203 and report messages 211 to 213 are communicated between the OLT 104 and the ONUs 101 to 103.

The report messages 211 to 213 each store queue length request values that is quantities of data items remaining in the data buffers 304 of the ONUs 101 to 103. The gate messages 201 to 203 each store queue length request values obtained from the report messages 211 to 213 and transmission grant queue lengths calculated by a Dynamic Bandwidth Allocation (DBA) scheduler 301 in the OLT 104. It is possible for the ONUs 101 to 103 to send to the OLT 104 the quantities of data items indicated by the transmission grant queue lengths stored in the gate messages 201 to 203.

Next, referring to FIGS. 3 and 4, description will be given of a control operation of the DBA scheduler 301.

First, the ONUs 101 to 103 send report messages 211 to 213 having stored queue length request values to the OLT 104 (step A1).

The DBA scheduler 301 receives, in a DBA cycle n 401, report messages 211 to 213 from the ONUs 101 to 103 under control of the OLT 104 and acquires the queue length request values from the respective report messages (step A2).

Subsequently, in a DBA cycle n+1 402, the DBA scheduler 301 calculates bands to be allocated to the respective ONUs 101 to 103 to attain the transmission grant queue lengths according to a DBA algorithm 311 (step A3).

The DBA scheduler 301 transmits, to the ONUs 101 to 103, gate messages 201 to 203 respectively having stored the transmission grant queue lengths and the queue length request values respectively attained from the ONUs 101 to 103 (step A4).

The ONUs 101 to 103 each receive the gate messages 201 to 203 from the OLT 104 (step A5). According to the transmission grant queue lengths in the gate messages 201 to 203 from the OLT 104, the ONUs 101 to 103 send transmission data items to the OLT 104 (step A6). Each ONU sends the data to the OLT 104 according to transmission timing stored in the associated gate message.

Referring now to FIGS. 5 and 6, description will be given of the DBA algorithm of the conventional art. FIG. 5 shows the DBA algorithm 311 in a flowchart, and FIG. 6 shows parameters used by the algorithm 311.

The parameters for the DBA algorithm 311 include a queue length request value RBWn (no. 5 in FIG. 6) requested by each ONU (101 to 103) and SLA parameters such as a maximum band limit value MaxBWn (no. 2 in FIG. 6), a minimum band guarantee value MinBWn (no. 3 in FIG. 6), and a fixed band value FBWn (no. 4 in FIG. 6).

These parameters are represented in the units of TQ indicating a time length granted for transmission in a DBA cycle. Therefore, the value in the units of TQ can be converted into a value in the units of bits per second (bps) as follows:
[bsp]=each parameter [TQ]/DBA cycle [TQ]×1 Gbps (Gigabits per second).

For example, the maximum band limit value MaxBWn [TQ] is converted into [bps] as follows:
MaxBWn [bps]=MaxBWn [TQ]/DBA cycle [TQ]×1 Gbps.

Next, description will be given of the conventional DBA algorithm 311 shown in FIG. 5.

First, the DBA scheduler 301 receives the queue length request values RBWn of the ONUs 101 to 103 (step S1).

The DBA scheduler 301 executes processing to calculate the corrected fixed band values FBW′n and the remaining queue lengths Φn for the ONUs 101 to 103 (step S2).

In the FBW′n calculation for each ONU, the DBA scheduler 301 conducts comparison between the queue length request value RBWn, the minimum band guarantee value MinBWn, and the fixed band value FBWn to calculate the corrected fixed band values FBW′n as shown in FIG. 7.

Condition 1: If “RBWn≧MinBWn>FBWn”, FBW′n=MinBWn.

Condition 2: If “MinBWn>RBWn≧FBWn”, FBW′n=RBWn.

Condition 3: Otherwise (other than conditions 1 and 2), FBW′n=FBWn.

In the calculation of the remaining queue length Φn, the DBA scheduler 301 subtracts the corrected fixed band value FBW′n from the queue length request value RBWn (RBWn−FBW′n) as shown in FIG. 8 to resultantly calculate the remaining queue length Φn (a request queue length not allocated).

That is, if RBWn≧FBW′n, Φn=RBWn−FBW′n.

If RBWn<FBW′n, Φn=0.

Next, the DBA scheduler 301 calculates the remaining band TBW at this point of time (step S3).

The DBA scheduler 301 conducts the calculation: TBW=DBA cycle−ΣFBW′n.

The DBA scheduler 301 then calculates the dynamic allocation band value to dynamically allocate the remaining band TBW to the ONUs 101 to 103 according to the ratio of the remaining queue length Φn (step S4).

That is, DBWn is calculated as follows:
DBWn=TBW×Φn/ΣΦn.

The DBA scheduler 301 adds the corrected fixed band value FBW′n attained in step S2 to the dynamic allocation band value DBWn obtained in step S4 (FBW′n+DBWn) to calculate the temporary allocation band TABWn (step S5).

That is, TABWn is calculated as follows:
TABWn=FBW′n+DBWn.

Thereafter, the temporary allocation band TABWn attained in step S5 is compared with the maximum band limit value MaxBWn (step S6).

If TABWn≧MaxBWn, since the temporary allocation band TABWn is equal to or more than the maximum band limit value MaxBWn, TABWn is updated to MaxBWn.

If TABWn<MaxBWn, since the temporary allocation band TABWn is less than the maximum band limit value MaxBWn, TABWn is not updated.

Next, a check is made to discriminate the ONU for which the band allocation is completed from the ONU for which the band allocation is not completed (step S7).

When the temporary allocation band TABWn is updated to the maximum band limit value MaxBWn in step S6, TABWn is compared with the queue length request value RBWn.

If TABWn≦RBWn, the final allocation band value ABWn of the ONUn (n is an integer and ranges from one to three in this situation) is set to TABWn to thereby complete the band allocation.

If the temporary allocation band TABWn was not updated in step S6, the DBA scheduler 301 calculates TABWn and the remaining queue length Φn.

If RBWn≧TABWn, Φn=RBWn−TABWn.

If RBWn<TABWn, Φn=0. The final allocation band value ABWn of the ONUn for which Φn is zero (Φn=0) is set to RBWn to thereby complete the band allocation.

The DBA scheduler 301 updates the remaining band TBW (step S8).

The DBA scheduler 301 conducts a calculation of TBW: TBW=DBA cycle−ΣABWm−TABWn (m indicates an ONU for which the allocation is completed and n indicates an ONU for which the allocation is not completed).

Next, it is determined whether the band allocation is to be carried out again, namely, whether a loop of steps for the band allocation is required (step S9).

The loop is required if the remaining band TBW attained in step 8 is more than zero and there exists at least one ONU for which the band allocation is not completed (yes in step S9). The flow then goes to step S4 to calculate the dynamic allocation band value DBWn.

In the other cases, namely, if TBW is zero or the band allocation is completed for all ONUs, it is determined that the loop is not required (no in step S9) and the band allocation is terminated.

According to the conventional DBA algorithm 311 described above, the final allocation band values ABWn are calculated for the ONUs 101 to 103 respectively according to the ratios of the queue request values RBWn from the respective ONUs 101 to 103. As a result, the gate messages each containing the transmission grant queue lengths including the final allocation band values are transmitted to the ONUs 101 to 103.

As a document filed prior to the present invention, there exists, for example, Japanese Patent Application Laid-Open Ser. No. 2004-336578 describing a point-to-multipoint optical transmission system in which an OLT is connected via optical transmission paths to a plurality of ONUs. The OLT allocates bands to the ONUs using a downstream signal and each ONU transmits an upstream signal to the OLT using a time slot of the band allocated by the OLT. The OLT includes a communication request quantity accumulating unit which accumulates a communication request quantity contained in a received communication request signal to thereby obtain for each ONU an accumulated communication request quantity as a result of the accumulation of the quantities in the past, and a band allocation unit for allocating to each ONU an upstream band using a weight according to the accumulated communication request quantity of the ONU calculated by the communication request quantity accumulating unit. It is therefore possible for the OLT to efficiently allocate a band according to the communication quantity in the past obtained through a simple calculation.

There exists, for example, Japanese Patent Application Laid-Open Ser. No. 2005-012800 describing a dynamic bandwidth allocation method devised in consideration of a multiplexed service using the GE-PON in which one OLT is coupled via the ODN with a large number of ONUs and in which the OLT allocates a bandwidth to each ONU in association with a bandwidth request issued from the ONU for data transmission. The method includes a stage of allocating a minimum band guaranteed for each service requested from the ONU in all available bandwidths and a stage in which after the minimum band is allocated to all ONUs having requested the bandwidth, when there exists a currently available bandwidth in the available bandwidths, the bandwidth requested from the ONU is allocated if the sum of the bandwidths requested by the ONUs is less than the currently available bandwidth. If the sum of the bandwidths is more than the currently available bandwidth, a new request bandwidth is determined for each ONU in consideration of a queue size of the ONU and the weight value for each queue to allocate a bandwidth in proportion to the new request bandwidth.

The DBA algorithm 311 of the conventional art shown in FIG. 5 is attended with problems to be solved.

The first problem resides in that in a state of congestion, since the data buffer 304 of each ONU (101 to 103) is finite, one and the same queue length request value RBWn is sent from the ONUs 101 to 103 to the OLT 104. In the conventional DBA algorithm 311 of FIG. 5, the final allocation band values ABWn finally allocated to the respective ONUs are calculated according to the ratios of the final allocation band values RBWn respectively received from the ONUs. Therefore, the OLT 104 distributes the values RBWn to be finally allocated to the ONUs, according to one and the same ratio thereto.

This results in a disadvantage that the final allocation band values RBWn respectively allocated to the ONUs do not indicate bands which guarantee impartiality between the service levels of the terminals.

Assume a case in which, for example, the maximum band limit value MaxBWn is 1000 Mbps for two ONUs, i.e., ONU1 101 and ONU2 102 and 100 Mbps for ONU3 103. However, for simple description, it is assumed for the other SLA that MaxBWn is 0 Mpbs for any ONU. Assume also that DBA cycle is set to 1000 TQ in the conventional DBA algorithm 311.

For all ONUs 101 to 103, the traffic from the communication terminals 121 to 123 is the maximum traffic of 1000 Mbps. Therefore, it is assumed that there occurs a state of congestion and each ONU sends to the OLT 104 a report message containing the maximum value MaxBuf of the data buffer 304 as the queue length request value RBWn.

Therefore, in the DBA algorithm 311 of FIG. 5, the queue length request value RBWn=MaxBuf is acquired in step S1.

In step S2, the value of RBWn, the minimum band guarantee value MinBWn, and the fixed band value FBWn are compared with each other to calculate the corrected fixed band value FBW′n.

Condition 1: If “RBWn≧MinBWn>FBWn”, FBW′n=MinBWn.

Condition 2: If “MinBWn>RBWn≧FBWn”, FBW′n=RBWn.

Condition 3: Otherwise (namely, other than conditions 1 and 2), FBW′n=FBWn.

Since the fixed band value FBWn is zero and the minimum band guarantee value MinBWn is zero, condition 1 is satisfied and hence the corrected fixed band value FBW′n is zero.

The remaining queue length Φn is obtained as follows:
RBWn−FBW′n=MaxBuf−0=MaxBuf.

Next, in step S3, the remaining band TBW is attained as follows:
DBW cycle−ΣFBW′n=1000 Mbps−0=1000 Mbps.

In step S4, the dynamic allocation band value DBWn is calculated as follows:
TBW×Φn/ΣΦn=1000 Mbps×MaxBuf/3MaxBuf=333 Mbps.

In step S5, the temporary allocation band TABWn is acquired as follows:
FBW′n+DBWn=0+333 Mbps=333 Mbps.

In step S6, if TAB≧MaxBWn, TABWn is updated to MaxBWn. If TAB<MaxBWn, TABWn is not updated.

Under the conditions that the maximum band limit value of ONU1 101, i.e., MaxBW1 is 1000 Mbps, the maximum band limit value of ONU2 102, i.e., MaxBW2 is 1000 Mbps, and the maximum band limit value of ONU3 103, i.e., MaxBW3 is 100 Mbps, the temporary allocation band TABW3 of the ONU3 103 is updated to 100 Mbps. Therefore, the temporary allocation bands TABW1, TABW2, and TABW3 are set to 333 Mbps, 333 Mbps, and 100 Mbps, respectively.

In step S7, ONUs for which allocation is not completed is sought. It is resultantly determined that the allocation is completed for the ONU1 101 and the ONU2 102 and the allocation is not completed for the ONU3 103.

Since the temporary allocation bands TABW1 and TABW2 of the ONU1 101 and ONU2 102 have not been updated, the DBA scheduler 301 calculates the remaining queue length: Φn=RBWn−TABWn. The remaining queue length Φn of the ONU1 101 is obtained as follows: Φ1=RBW1−TABW1=MaxBuf−333. The remaining queue length Φn of the ONU2 102 is obtained as follows:Φ2=RBW2−TABW2=MaxBuf−333.

In step S8, the DBA scheduler 301 obtains the remaining band as follows:TBW=DBA cycle−ΣABWm−TABWn=1000 Mbps−2×333 Mbps−100 Mbps=234 Mbps.

Thereafter, control goes to step S4 in the loop to calculate the dynamic allocation band value as DBWn=TBW×Φn/ΣΦn=234 Mbps×(MaxBuf−333 Mbps)/(2×(MaxBuf−333 Mbps))=117 Mbps.

Therefore, the final allocation band value of the ONU1 101 is: ABW1=333 Mbps+117 Mbps=450 Mbps. Similarly, the final allocation band value of the ONU2 102 is: ABW2=333 Mbps+117 Mbps=450 Mbps. The final allocation band value of the ONU3 103 is: ABW3=100 Mbps.

The band ratio among ONU1 101, ONU2 102, and ONU3 103 is 9:9:2. It is therefore not possible to implement the ratio 10:10:1 during the service by the ONU1 101 and the ONU2 102 that have a maximum band limit value MaxBWn of 1000 Mbps and the ONU3 103 that has a maximum band limit value MaxBWn of 100 Mbps.

The second problem is as follows. When the maximum band limit value MaxBWn is small or when the system operates with low-speed traffic, the final allocation band value ABWn is less than the ONU remaining frame length in any situation. Therefore, a frame cannot be delivered and the data is kept remained in the data buffer 304 of each ONU (101 to 103).

If the frame length of a frame remaining in the ONU (101 to 103) is, for example, 1500 bytes, the transmission grant queue length required between the GE and the PON is (1500 bytes+20 bytes)/2=760 TQ. However, according to the conventional DBA algorithm 311, even if the transmission grant queue length finally allocated is less than 760 TQ, the queue length is stored in a gate message and the message is sent to the ONU (101 to 103). However, even when the gate message less than 760 TQ is received, the ONU cannot transmit the 1500-byte frame remaining in the data buffer 304. Therefore, the long frame is kept remained in the data buffer 304.

The third problem resides in that the Ethernet frame is a variable-length frame and hence there may occur a case in which the entire band allocated as above cannot be used. Since the line utilization efficiency is not taken into consideration in the DBA algorithm 311 of the conventional art, it possibly occurs that the execution throughput is considerably deteriorated.

Although Japanese Patent Application Laid-Open Ser. Nos. 2004-336578 and 2005-012800 describe techniques to allocate bands to the respective ONUs, consideration has not been given to implementation of band control that guarantees impartiality between the service levels of the ONUs.

### SUMMARY OF THE INVENTION

It is therefore an object of the present embodiments to provide a band allocation control apparatus, a band allocation control method, and a band allocation control program capable of achieving band control which guarantees impartiality between the service levels of the ONUs.

The object is achieved according to the present invention having aspects as below.

In accordance with the present invention, there is provided a band allocation control apparatus for controlling bands to be allocated to a plurality of Optical Network Units (ONUs) including a band allocating unit for setting an allocation band to be allocated to each of the ONUs according to a ratio of maximum band limit values of the ONUs.

In the band allocation control apparatus, the band allocating unit sets an allocation band for a remaining band allocatable in the band allocation control apparatus according to the ratio of maximum band limit values. The band allocating unit distributes the remaining band to the ONUs.

The band allocation control apparatus further includes a control table for controlling the maximum band limit values of the ONUs. The band allocating unit sets the allocation band to be allocated to each of the ONUs according to the ratio of the maximum band limit values controlled by the control table.

The band allocation control apparatus further includes a queue length request value acquiring unit for acquiring a queue length request value of an ONU, a collected fixed band value calculating unit for calculating a collected fixed band value according to the queue length request value, and a remaining band calculating unit for calculating a remaining band allocatable in the band allocation control apparatus, according to the collected fixed band value. The band allocating unit sets an allocation band for the remaining band according to the maximum band limit value.

In the band allocation control apparatus, the maximum band limit value is one of Service Level Agreement (SLA) parameters set for each of the ONUs.

The band allocation control apparatus further includes a determining unit for determining whether the allocation band allocated by the band allocating unit is less than the queue length request value and the allocation band has reached a Maximum Transmission Unit (MTU) traffic band required for traffic to pass a frame having an MTU length and an allocation band changing unit for changing the allocation band to a fixed band value of an ONU if the determining unit determines that the allocation band is less than the queue length request value and has reached the MTU traffic band.

The band allocation control apparatus further includes an allocation band correcting unit for correcting the allocation band allocated by the band allocating unit to be an integral multiple of the MTU traffic band.

In the band allocation control apparatus, the allocation band correcting unit corrects, if the allocation band allocated by the band allocating unit is less than the queue length request value, the allocation band to be an integral multiple of the MTU traffic band.

In accordance with the present embodiments, there is provided a band allocation control method for use with a band allocation control apparatus for controlling bands to be allocated to a plurality of ONUs. The method includes the band allocating step for setting an allocation band to be allocated to each of the ONUs according to a ratio of maximum band limit values of the ONUs.

In the band allocation control method, the band allocating step includes setting an allocation band for a remaining band allocatable in the band allocation control apparatus, the remaining band according to the ratio of maximum band limit values, and distributing the remaining band to the ONUs.

In the band allocation control method, the band allocation control apparatus includes a control table for controlling for each of the ONUs the maximum band limit values of the ONUs. The band allocating step includes setting the allocation band to be allocated to each of the ONUs, according to the ratio of the maximum band limit values controlled by the control table.

The band allocation control method further includes the queue length request value acquiring step of acquiring a queue length request value of an ONU, the collected fixed band value calculating step of calculating a collected fixed band value according to the queue length request value, and the remaining band calculating step of calculating a remaining band allocatable in the band allocation control apparatus, according to the collected fixed band value. The band allocating step includes setting the allocation band for the remaining band allocated to the ONUs according to the ratio of maximum band limit values.

In the band allocation control method, a maximum band limit value is one of SLA parameters set for each of the ONUs.

The band allocation control method further includes the determining step of determining whether the allocation band allocated by the band allocating step is less than the queue length request value and the allocation band has reached an MTU traffic band required for traffic to pass a frame having an MTU length and the allocation band changing step of changing the allocation band to a fixed band value of the ONU if the determining step determines that the allocation band is less than the queue length request value and has reached the MTU traffic band.

The band allocation control method further includes the allocation band correcting step of correcting the allocation band allocated by the band allocating step to be an integral multiple of the MTU traffic band.

In the band allocation control method, the allocation band correcting step includes correcting, if the allocation band allocated by the band allocating step is less than the queue length request value, the allocation band to be an integral multiple of the MTU traffic band.

In accordance with the present invention, there is provided a computer program product embodied on a computer-readable medium and comprising code that, when executed, causes a computer to perform band allocating processing for setting an allocation band for each of the ONUs based on a ratio of maximum band limit values of the ONUs.

In the computer program product, the band allocating processing sets an allocation band for a remaining band allocatable in the band allocation control apparatus according to the ratio of maximum band limit values, and the band allocating processing distributes the remaining band to the ONUs.

In the computer program product, the band allocating processing sets the allocation band to be allocated to each of the ONUs, according to the ratio of the maximum band limit values controlled by a control table.

The computer program product further includes queue length request value acquiring processing for acquiring a queue length request value of the ONU, collected fixed band value calculating processing for calculating a collected fixed band value according to the queue length request value, and remaining band calculating processing for calculating a remaining band allocatable in the band allocation control apparatus, according to the collected fixed band value. The band allocating processing sets an allocation band for a remaining band calculated by the remaining band calculating processing according to the ratio of maximum band limit values.

In the computer program product, a maximum band limit value is one of SLA parameters set for each of the ONUs.

The computer program product further includes determining processing for determining whether the allocation band allocated by the band allocating processing is less than the queue length request value and the allocation band has reached an MTU traffic band required for traffic to pass a frame having an MTU length and allocation band changing processing for changing the allocation band to a fixed band value of the ONU if the determining processing determines that the allocation band is less than the queue length request value and has reached the MTU traffic band.

The computer program product further includes allocation band correcting processing for correcting the allocation band allocated by the band allocating processing to be an integral multiple of the MTU traffic band.

In the computer program product, the allocation band correcting processing corrects, if the allocation band allocated by the band allocating processing is less than the queue length request value, the allocation band to be an integral multiple of the MTU traffic band.

In the band allocation control apparatus, the band allocation control method, and the computer program product for a band allocation control according to the present embodiments, allocation bands to be allocated to the respective ONUs are determined based on the maximum band limit values of the ONUs and hence it is possible to implement band control which guarantees impartiality between the service levels of the ONUs.

### BRIEF DESCRIPTION OF THE DRAWINGS

The objects and features of the present invention will become more apparent from the consideration of the following detailed description taken in conjunction with the accompanying drawings in which:

FIG. 1 is a schematic block diagram showing a system configuration of a GE-PON system of the conventional art;

FIG. 2 is a block diagram showing an internal configuration of the OLT 104 and the ONUs 101 to 103 of the GE-PON system;

FIG. 3 is a graphic diagram showing gate messages 210 to 203 and report messages 211 to 213 alternately transmitted between the OLT 104 and the ONUs 101 to 103;

FIG. 4 is a graphic diagram showing a control operation of the DBA scheduler 301;

FIG. 5 is a flowchart of the conventional DBA algorithm 311;

FIG. 6 is a table showing parameters used in the DBA algorithm 311;

FIG. 7 is a schematic diagram for explaining a method of calculating the corrected fixed band value FBW′n;

FIG. 8 is a graphic diagram for explaining a method of obtaining the remaining queue length Φn;

FIG. 9 is a block diagram showing a system configuration of an embodiment of a GE-PON system;

FIG. 10 is a flowchart of a DBA algorithm 1211 of the embodiment;

FIG. 11 is a table showing parameters used in the DBA algorithm 1211;

FIG. 12 is a schematic diagram showing conditions 1 to 4 in step S112 of the DBA algorithm 1211;

FIG. 13 is a graphic diagram showing conditions 5 and 6 in step S112 of the DBA algorithm 1211;

FIG. 14 is a graph showing the line utilization efficiency of the DBA algorithm 1211; and

FIG. 15 is a graph showing the line utilization efficiency in actual traffic.

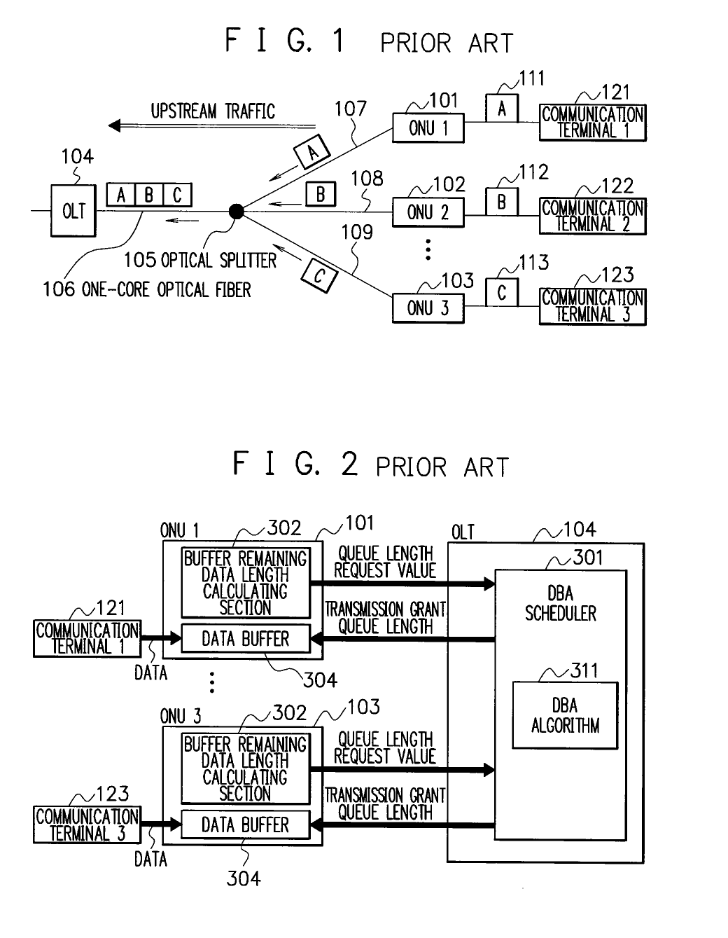

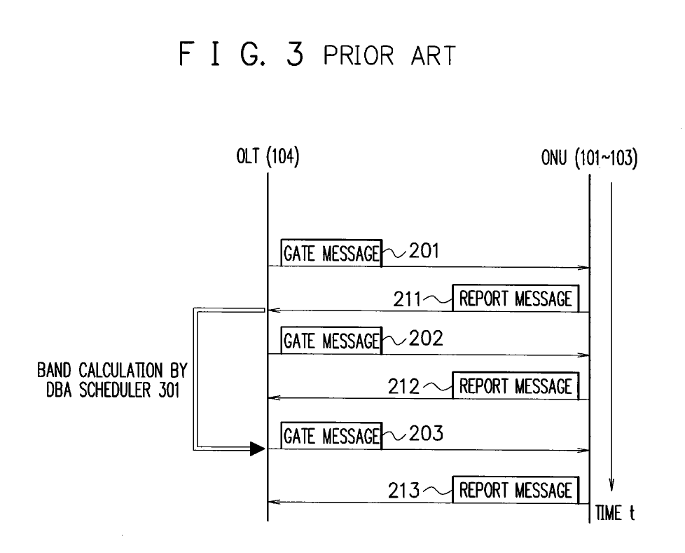

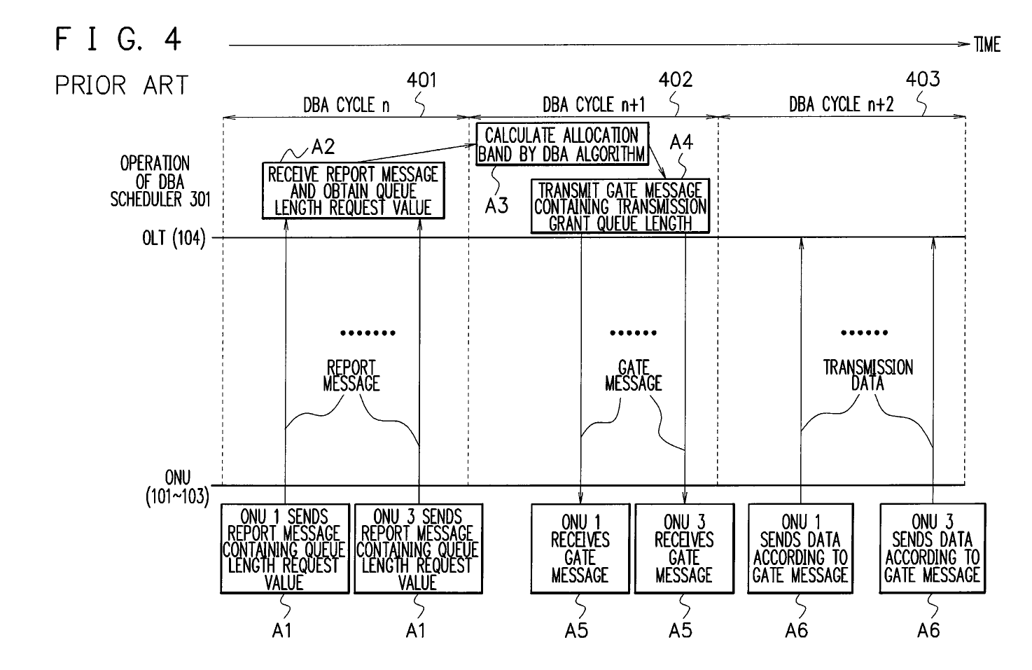

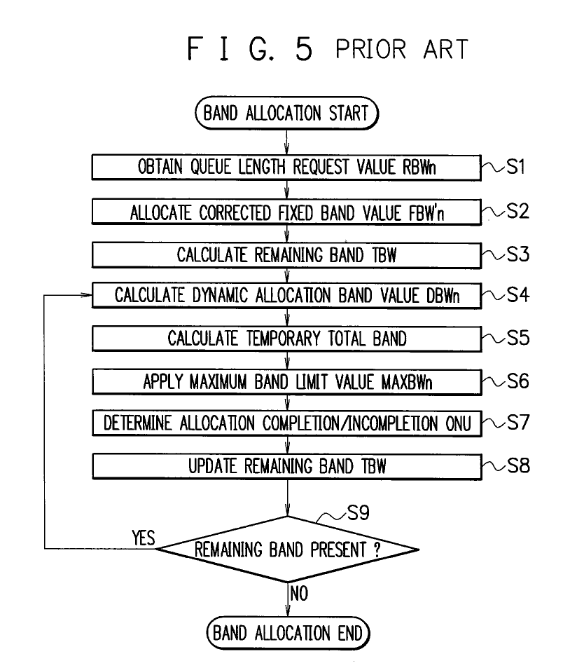

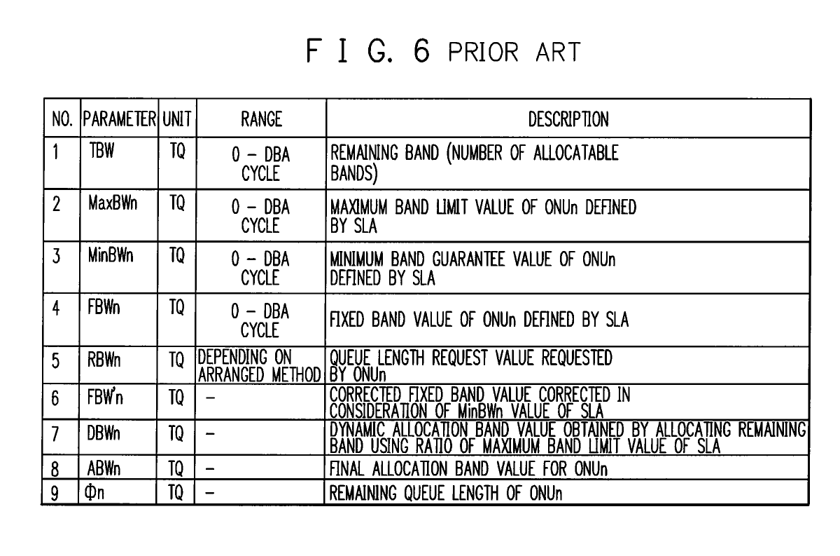

### DESCRIPTION OF THE EMBODIMENTS

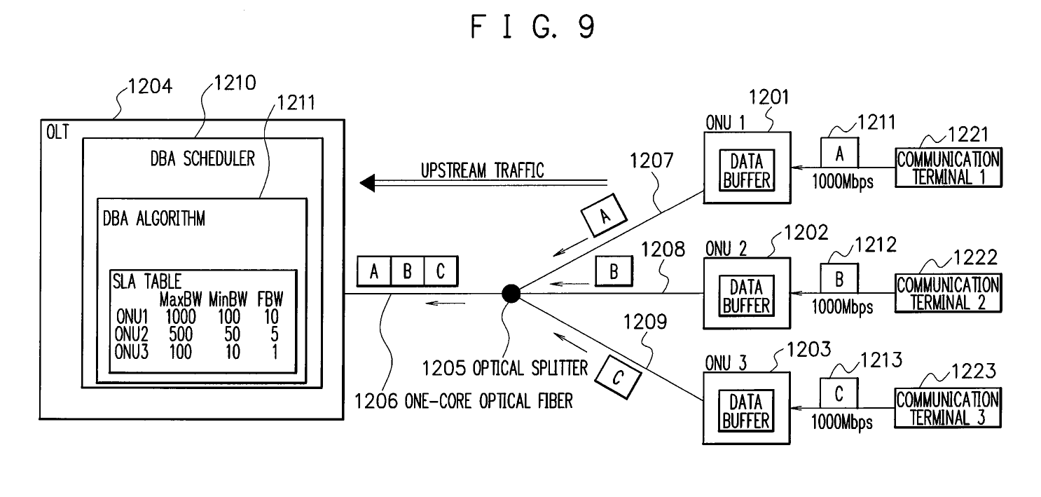

Referring now to FIG. 9, description will be given of aspects of a band allocation control apparatus in an embodiment.

In the embodiment, the band allocation control apparatus 1204 controls bands to be allocated to a plurality of ONUs 1201 to 1203. The apparatus 1204 sets the allocation bands according to the ratios of the maximum band limit values of the ONUs 1201 to 1203. This makes it possible to implement band control capable of guaranteeing impartiality between the service levels of the ONUs 1201 to 1203. Referring now to the accompanying drawings, description will be given of the embodiment of the band allocation control apparatus. In the following description, the apparatus 1204 will be referred to as an Optical Line Terminal (OLT).

Referring to FIG. 9, description will be given of a system configuration of the GE-PON system in the embodiment. FIG. 9 shows the system configuration of the GE-PON system.

In the embodiment of the GE-PON system, the OLT 1204 communicates with three ONUs, i.e., ONU1 1201, ONU2 1202, and ONU3 1203.

The OLT 1204 is connected via a one-core optical fiber cable 1206 to an optical splitter 1205, a branch unit. The optical splitter 1205 is connected, on its uplink side, via one-core optical fiber cables 1207 to 1209 respectively to a plurality of ONUs 1201 to 1203. The ONUs are connected to communication terminals 1221 to 1223 respectively with a one-to-one correspondence established therebetween. The communication terminals 1221 to 1223 transmit data items 1211 to 1213 to the ONUs 1201 to 1203 respectively.

The OLT 1204 includes a DBA scheduler 1210 that controls upstream traffic of the respective ONUs 1201 to 1203 according to a DBA algorithm 1211.

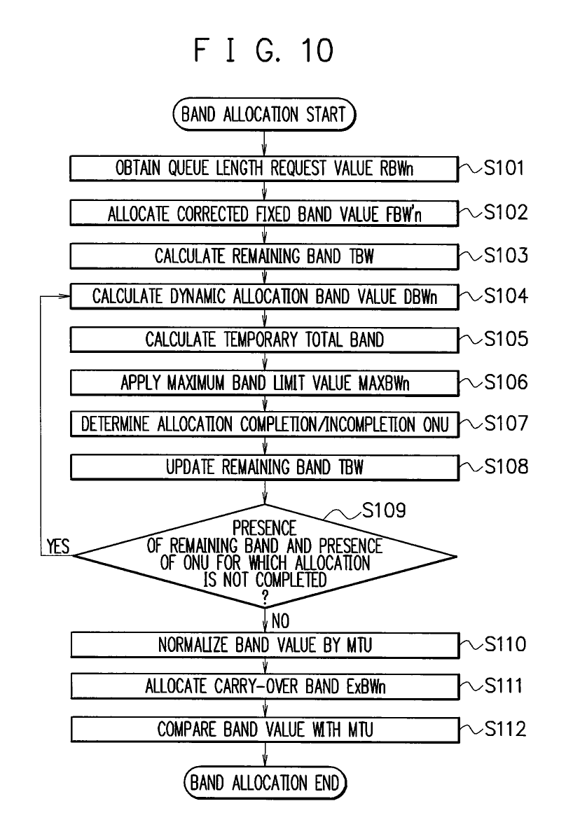

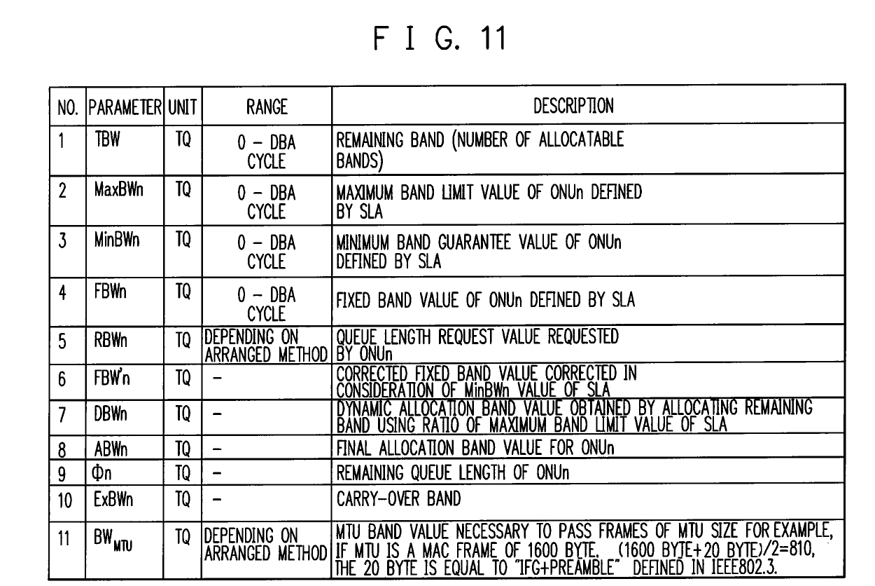

Next, referring to FIGS. 10 and 11, description will be given of a control operation of the DBA algorithm 1211 in the embodiment. FIG. 10 shows a flow of the DBA algorithm 1211 and FIG. 11 shows parameters employed by the DBA algorithm 1211.

First, the DBA scheduler 1210 acquires the queue length request values RBWn of the ONUs 1201 to 1203 (step S101).

The DBA scheduler 1210 then executes processing to calculate the corrected fixed band values RFW′n and the remaining queue lengths Φn of the ONUs 1201 to 1203 (step S102).

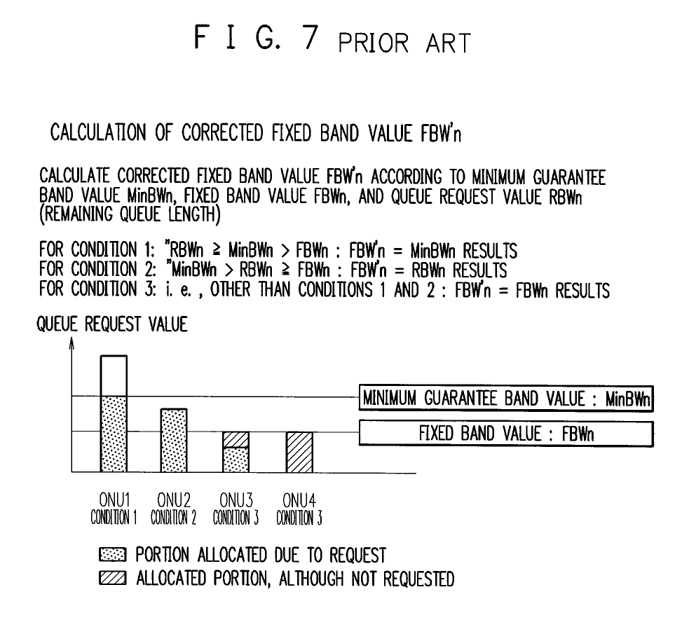

In the RFW′n calculation, the queue length request value RBWn, the minimum band guarantee value MinBWn, and the fixed band value FBWn are compared with each other to obtain the corrected fixed band values RFW′n as shown in FIG. 7.

Condition 1: “RBWn≧MinBWn>FBWn”, FBW′n=MinBWn.

Condition 2: “MinWn>RBWn≧FBWn”, FBW′n=RBWn.

Condition 3: Otherwise (other than conditions 1 and 2), FBW′n=FBWn.

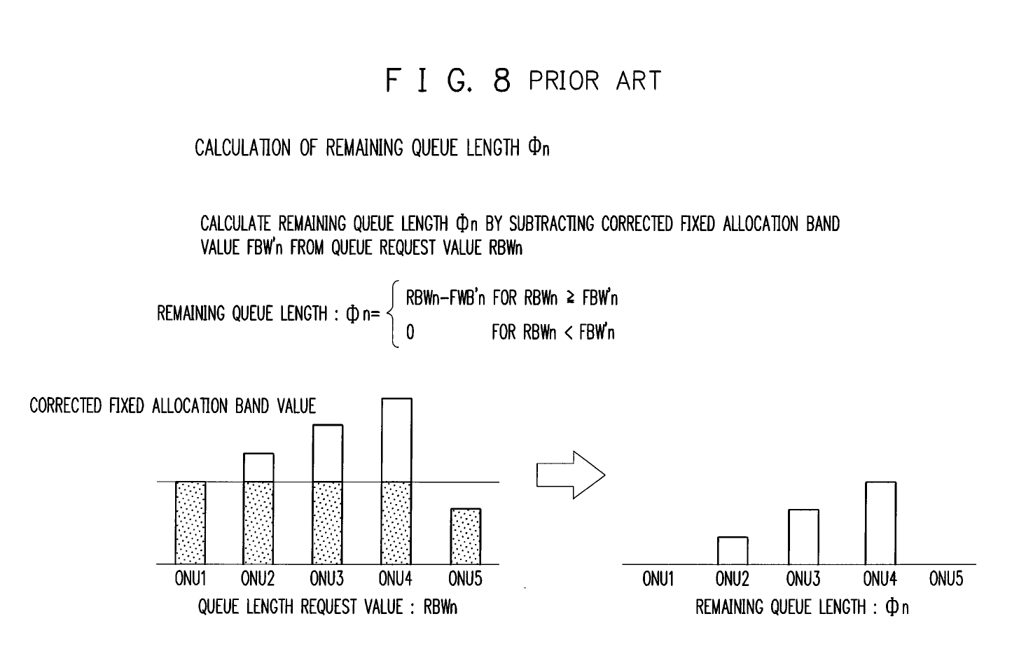

To calculate the remaining queue length Φn, the DBA scheduler 1210 subtracts the corrected fixed band value FBW′n from the queue length request value RBWn (RBWn−FBW′n) as shown in FIG. 8 to thereby attain the remaining queue length Φn (a request queue length not allocated).

That is, if RBWn≧FBW′n, Φn=RBWn−FBW′n.

If RBWn<FBW′n, Φn=0.

Subsequently, the DBA scheduler 1210 calculates the remaining band TBW at this point of time (step S103).

The DBA scheduler 1210 counts the number of ONUs for which the carry-over band ExBWn is more than zero to calculate TBW: TBW=DBA cycle−ΣFBW′n−BW_{MTU}×m (m is the number of ONUs for which ExBWn is more than zero). In this connection, the carry-over band ExBWn is a parameter possibly updated in steps S110, S111, and S112, which will be described later.

Thereafter, the DBA scheduler 1210 calculates the dynamic allocation band value DBWn to dynamically allocate the remaining band TBW to the ONUs 101 to 103 according to the ratio of the maximum band limit value MaxBWn (step S104).

That is, DBWn is calculated:
DBWn=TBW×MaxBWn/ΣMaxBWn.

The DBA scheduler 1210 then adds the corrected fixed band value FBW′n obtained in step S102 to the dynamic allocation band value DBWn acquired in step S104 (FBW′n+DBWn) to calculate the temporary allocation band TABWn (step S105).

The calculation of TABWn is carried out:
TABWn=FBW′n+DBWn.

Next, the temporary allocation band TABWn obtained in step S105 is compared with the maximum band limit value MaxBWn. If TABWn is more than MaxBWn, TABWn is updated as below. Otherwise, TABWn is not updated (step S106).

If TABWn≧MaxBWn, the DBA scheduler 1210 sets TABWn=MaxBWn.

If TABWn<MaxBWn, the DBA scheduler 1210 does not update TABWn.

Subsequently, a check is made to discriminate the ONU for which the band allocation is completed from the ONU for which the band allocation is not completed (step S107).

If the temporary allocation band TABWn obtained in step S105 is updated to the maximum band limit value MaxBWn in step S106, TABWn is compared with the queue length request value RBWn.

If TABWn≦RBWn, the final allocation band value ABWn is set to TABWn to thereby complete the band allocation.

If the temporary allocation band TABWn obtained in step S105 has not been updated in step S106, the DBA scheduler 1210 calculates TABWn and the remaining queue length Φn as follows:
If RBWn≧TABWn, Φn=RBWn−TABWn.

If RBWn<TABWn, Φn=0. For the ONUn for which Φn=0 is determined, the final allocation band value ABWn is set to RBWn, and then the band allocation is completed.

The DBA scheduler 1210 then updates the remaining band TBW (step S108).

In the calculation of TBW, using the final allocation band value of the ONU for which the allocation is completed in step S107 and that of the ONU for which the allocation is not completed in step S107, the DBA scheduler 301 calculates TBW: TBW=DBA cycle−ΣABWm−TABWn (m indicates an ONU for which the allocation is completed and n indicates an ONU for which the allocation is not completed).

Subsequently, a check is made to determine whether a loop of steps for the band allocation is again required (step S109).

It is determined that the loop is required if the remaining band TBW calculated in step 108 is more than zero and there exists at least one ONU for which the band allocation is not completed (yes in step S109). The process goes to step S104.

In the other cases, that is, if TBW is zero or the band allocation is completed for all ONUs, it is assumed that the loop is not required (no in step S109) and the process goes to step S110. If TBW is zero, ABWn is set to TABWn for the ONU for which the allocation is not completed. The process goes to step S110.

Next, the final allocation band value ABWn is normalized to an integral multiple of the MTU traffic band BW_{MTU} to correct the final allocation band value ABWn (step S110). The remainder is added to ExBWn.

However, if RBWn<TABWn, Φn is set to zero. The normalization is not conducted for the ONUn for which the final allocation band value ABWn is RBWn in step S109.

In other words, the DBA scheduler 1210 calculates ABWn and ExBWn: ABWn=ABWn−(ABWn mod BW_{MTU}); and ExBWn=ExBWn+(ABWn mod BW_{MTU}).

However, if RBWn<TABWn and Φn is set to zero, the operation is not conducted for the ONUn for which the final allocation band value ABWn is RBWn in step S109.

Then, the remaining band TBW is updated as below.

First, BW_{MTU}×m, which was subtracted in step S103, is added to TBW. Namely, TBW=TBW+BW_{MTU}×m.

For the ONUn for which the allocation is not completed in step S107 and for which the carry-over band ExBWn is more than zero, the MTU traffic band BW_{MTU} is added to the final allocation band value ABWn (ABWn+BW_{MTU}). At the same time, the MTU traffic band BW_{MTU} is subtracted from the carry-over band ExBWn (ExBWn−BW_{MTU}).

If there exists a plurality of ONUn for the above operation, the DBA scheduler 1210 executes processing in a random way as below to calculate the final allocation band value ABWn: ABWn=ABWn+BW_{MTU}. The scheduler 1210 also calculates ExBWn:
ExBWn=ExBWn−BW_{MTU}.

Since n≧m (n indicates an allocation-incomplete ONU, and m indicates an allocation-completed ONU), to keep the remaining band TBW in a range of positive values, each time the MTU traffic band BW_{MTU} is added to the final allocation band value ABWn (ABWn+BW_{MTU}), the remaining band is updated as follows: TBW=TBW−BW_{MTU}. The operation is repeatedly conducted until TBW is less than BW_{MTU} or until there does not exist any ONUn for which the inequality ExBWn>0 holds (step S111).

Next, the final allocation band value ABWn, the queue length request value RBWn, and the MTU traffic band BW_{MTU} are compared with each other to update the ABWn and the carry-over band ExWBn (step S112).

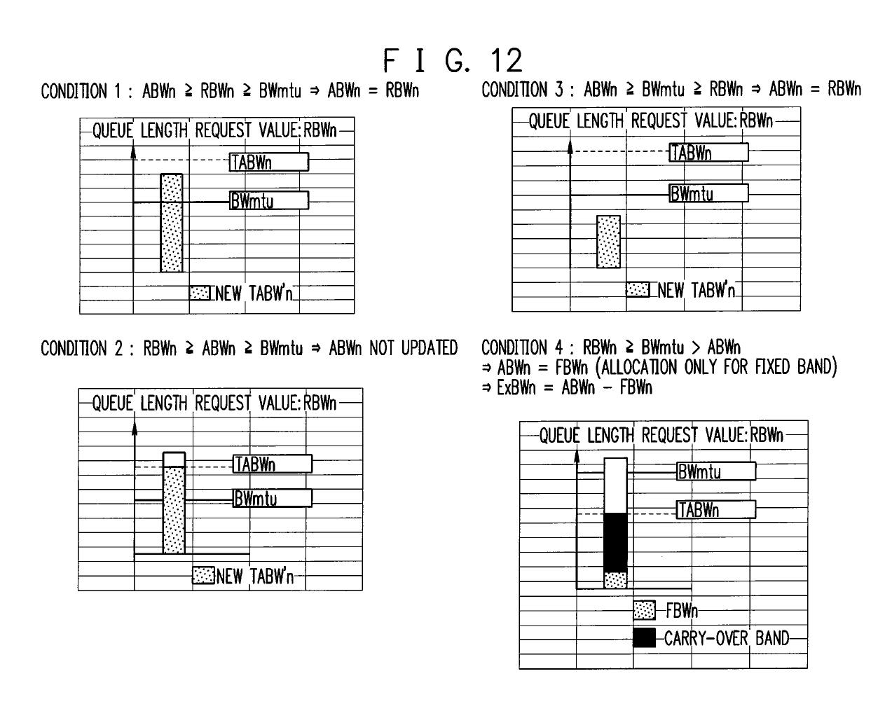

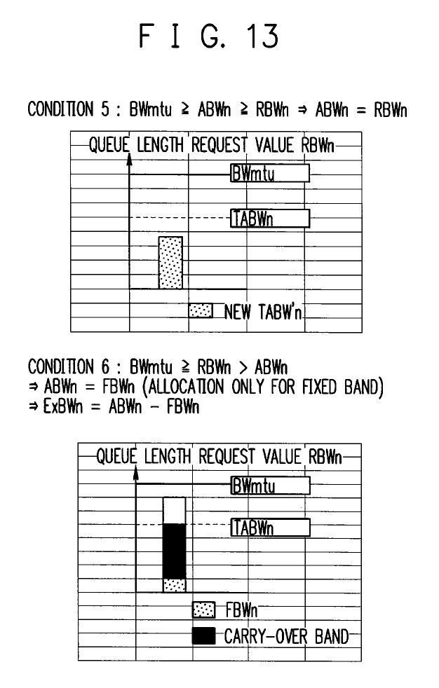

FIGS. 12 and 13 show the processing in step S112. FIG. 12 shows the processing for conditions 1 to 4 in step S112, and FIG. 13 shows the processing for conditions 5 and 6 in step S112.

Condition 1: If ABWn≧RBWn≧BW_{MTU}, ABWn=RBWn.

Condition 2: If RBWn≧ABWn≧BW_{MTU}, ABWn is not updated.

Condition 3: If ABWn≧BW_{MTU}≧RBWn, ABWn=RBWn.

Condition 4: If RBWn≧BW_{MTU}≧ABWn, ABWn=FBWn (allocation is conducted only for a fixed band) and ExBWn=ABWn−FBWn.

Condition 5: If BW_{MTU}≧ABWn≧RBWn, ABWn=RBWn.

Condition 6: If BW_{MTU}≧RBWn≧ABWn, ABWn=RBWn (allocation is conducted only for a fixed band) and ExBWn=ABWn−FBWn.

In the processing of operation in step S112, a check is made to determine whether the final allocation band value ABWn is less than the queue length request value RBWn and has reached the MTU traffic band BW_{MTU} required for the traffic to pass the frame of the MTU length. In condition 4 of FIG. 12 and condition 6 of FIG. 13, ABWn and the carry-over band ExBWn are updated.

As above, according to the DBA algorithm 1211 of the embodiment, to calculate the dynamic allocation value DBWn in step S104, the remaining band TBW is distributed according to the ratio of the maximum band limit value MaxBWn (an SLA parameter). Therefore, even in the state of congestion, it is possible to guarantee impartiality among the service levels of the ONUs 1201 to 1203.

By introducing the concept of the carry-over band ExBWn, a check is made in step S112 to determine whether the final allocation band value ABWn has reached the MTU traffic band BWMTU required for the traffic of the frame having the MTU length. Therefore, it is possible to avoid the disadvantage of the remaining of the long frame in the data buffer of the ONU (1201 to 1203).

Description will now be specifically given of processing of the operation in the DBA algorithm 1211 of the embodiment shown in FIG. 10. Assume that “DAB cycle=30000 TQ” and “MTU traffic band BW_{MTU}=810 TQ” are set to the algorithm 1211.

Assume also that the OLT 104 includes a control table with SLA parameters set to the ONUs 1201 to 1203 as below. The units are TQ, and the units in the parentheses are converted values in bits per second (bps).

<SLA Parameters of ONU1 1201>

Maximum band limit value MaxBW1=30000 (1000 Mbps)
Minimum band guarantee value MinBW1=3000 (100 Mbps)
Fixed band value FBW1=300 (10 Mbps)
   <SLA Parameters of ONU2 1202>
Maximum band limit value MaxBW2=15000 (500 Mbps)
Minimum band guarantee value MinBW2=1500 (50 Mbps)
Fixed band value FBW2=150 (5 Mbps)
   <SLA Parameters of ONU3 1203>
Maximum band limit value MaxBW3=3000 (100 Mbps)
Minimum band guarantee value MinBW3=300 (10 Mbps)
Fixed band value FBW3=30 (1 Mbps)

For each ONU (1201 to 1203), the buffer capacity (the maximum value of the queue length request value) of the data buffer is set to 50000 TQ.

It is also assumed that the system is in a state of congestion due to 1000 Mbps traffic from each of the communication terminals 1221 to 1223.

First, the DBA scheduler 1210 receives the queue length request values RBWn of all ONUs 1201 to 1203 (step S101).

Since the embodiment is in the state of congestion, RBWn is the value indicating the capacity of the data buffer of each ONU.

Therefore, RBW1=50000, RBW2=50000, and RBW3=50000.

Subsequently, for each ONU, the corrected fixed band value FBW′n and the remaining queue length Φn are calculated (step S102).

In the calculation of FBW′n, the queue length request value RBWn, the minimum band guarantee value MinBWn, and the fixed band value FBWn are compared with each other to obtain the corrected fixed band values FBW′n as shown in FIG. 7.

Condition 1: RBWn≧MinBWn>FBWn, FBW′n=MinBWn.

Condition 2: MinBWn>RBWn≧FBWn, FBW′n=RBWn.

Condition 3: Otherwise (other than conditions 1 and 2), FBW′n=FBWn.

Since RBW1=50000, MinBW1=3000, and FBW1=300 for the ONU1 1201, condition 1 is satisfied and FBW′1=MinBW1=3000 is obtained.

For the ONU2 1202, condition 1 holds since RBW2=50000, MinBW2=1500, and FBW2=150. This results in FBW′2=MinBW2=1500.

Condition 1 is also applicable for ONU3 1203 due to RBW3=50000, MinBW3=300, and FBW3=30. Therefore, FBW′3=MinBW3=300 is obtained.

In the calculation of the remaining queue length Φn, the DBA scheduler 1210 subtracts the corrected fixed band value FBW′n from the queue length request value RBWn (RBWn−FBW′n) as shown in FIG. 8 to attain Φn as a request queue length not allocated.

That is, if RBWn≧FBW′n, Φn=RBWn−FBW′n.

If RBWn<FBW′n, Φn=0.

For the ONU1 1201, RBW1 (50000)≧FBW′1 (3000), and hence Φ1 is attained as Φ1=RBW1−FBW′1=50000−3000=47000.

Since RBW2 (50000)≧FBW′2 (1500) for the ONU2 1202, Φ2 is calculated as Φ2=RBW2−FBW′2=50000−1500=48500.

For the ONU3 1203, RBW3 (50000)≧FBW′3 (300). Therefore, Φ3 is calculated as Φ3=RBW3−FBW′3=50000−300=49700.

Next, the remaining band TBW at this point of time is obtained (step S103).

The DBA scheduler 1210 calculates TBW: TBW=DBA cycle−ΣFBW′n−BW_{MTU}×m (m is the number of ONUs for which ExBWn is more than zero).

Assume that the carry-over band is set as ExBW1<0, ExBW2<0, and ExBW3<0 for the ONUs 1201 to 1203 at this point of time.

Since m=0, the remaining band TBW is obtained as follows:
TBW=DBA cycle−ΣFBW′n−BW_{MTU}×m=30000−(3000+1500+300)=30000−4800=25200.

The DBA scheduler 1210 then calculates the dynamic allocation band value DBWn to dynamically allocate the remaining band TBW to the ONUs 101 to 103 according to the ratio of the maximum band limit value MaxBWn (step S104).

In short, DBWn=TBW×MaxBWn/ΣMaxBWn.

For the ONU1 1201, DBW1 is obtained as DBW1=25200×30000/(30000+15000+3000)=15750.

Also, DBW2 of ONU2 is calculated as DBW2=25200×15000/(30000+15000+3000)=7875.

For the ONU3 1203, DBW3 is attained as DBW3=25200×3000/(30000+15000+3000)=1575.

Next, the DBA scheduler 1210 adds the corrected fixed band value FBW′n obtained in step S102 to the dynamic allocation band value DBWn attained in step S104 (FBW′n+DBWn) to calculate the temporary allocation band TABWn (step S105).

That is, the following calculation is carried out:
TABWn=FBW′n+DBWn.

For the ONU1 1201, TABW1 is acquired as TABW1=FBW′1+DBW1=3000+15750=18750.

Similarly, TAB2 of the ONU2 1202 is calculated as TABW2=FBW′2+DBW2=1500+7875=9375.

For the ONU3 1203, TABW3 is attained as TABW3=FBW′3+DBW3=300+1575=1875.

Thereafter, the temporary allocation band TABWn obtained in step S105 is compared with the maximum band limit value MaxBWn (step S106).

If TABWn≧MaxBWn, since the temporary allocation band TABWn is equal to or more than the maximum band limit value MaxBWn, TABWn is updated to MaxBWn.

If TABWn<MaxBWn, since the value of TABWn is less than that of MaxBWn, TABWn is not updated.

Therefore, TABW1 of the ONU1 1201 is 18750, i.e., less than 30000. Since TABW1 is less than MaxBW1 and is not updated, TABW1=18750.

For the ONU2 1202, TABW2 is 9375 and is less than 15000. TABW2 is less than MaxBW2 and is not updated, and TABW2=18750 is set.

TABW3 of the ONU3 1203 is 1875<30000. TABW3 is less than MaxBW3 and is hence not updated, and TABW1=1875 is attained.

Next, the DBA scheduler 1210 makes a check to discriminate the ONU for which the band allocation is completed from the ONU for which the band allocation is not completed (step S107).

If the temporary allocation band TABWn is updated to the maximum band limit value MaxBWn in step S106, the DBA scheduler 1210 compares TABWn with the queue length request value RBWn.

If TABWn≦RBWn, the final allocation band value ABWn of the ONUn is set to TABWn to thereby complete the band allocation.

If the value of TABWn has not been allocated in step S106, the DBA scheduler 1210 calculates TABWn and the remaining queue length Φn.

If RBWn>TABWn, Φn is obtained as Φn=RBWn−TABWn.

If RBWn<TABWn, Φn=0. For the ONUn for which Φn=0, the final allocation band value ABWn is set to RBWn to thereby complete the band allocation.

Therefore, since the temporary allocation band TABW is not updated for any ONU in step S106, the DBA scheduler 1210 calculates TABWn and Φn.

For the ONU1 1201, the remaining queue length Φ1 is attained as Φ1=RBW1−TABW1=50000−18750=31250>0. Therefore, it is assumed that the allocation is not completed.

The value of Φ2 of the ONU2 1202 is acquired a Φ2=RBW2−TABW2=50000−9375=40625>0. Similarly, it is assumed that the allocation is not completed.

Also, Φ3 of the ONU3 1203 is calculated as Φ3=RBW3−TABW3=50000−1875=48125>0. It is hence assumed that the allocation is not completed.

The DBA scheduler 1210 then updates the remaining band TBW (step S108).

To obtain TBW, the DBA scheduler 1210 conducts a calculation: TBW=DBA cycle−ΣABWa−TABWb (a indicates an ONU for which the allocation is completed and b indicates an ONU for which the allocation is not completed).

Therefore, TBW is attained as TBW=30000−0−(18750+9375+1875)=30000−30000=0.

Subsequently, a check is made to determine whether a loop of steps for the band allocation is required (step S109).

In the determination of the requirement for the loop, if the remaining band TBW attained in step 108 is more than zero and there exists at least one ONU for which the band allocation is not completed, it is determined that the remaining band TBW exists (yes in step S109). The process then goes to step S104 to obtain the dynamic allocation band value DBWn.

In the other cases, that is, if TBW is zero or the band allocation is completed for all ONUs, it is determined that the remaining band TBW is not existing (no in step S109) and the process goes to step S110.

If TBW=0, the DBA scheduler 1210 assumes ABWn=TABWn for the ONU for which the band allocation is not completed. The process goes to step S110.

Since TBW=0, it is assumed that the remaining band TBW is absent (no in step S109). For the ONU1 1201, the final allocation band value ABW1 is attained as ABW1=TABW1=18750.

The value ABW2 of the ONU2 1202 is calculated as ABW2=TABW2=9375.

Similarly, for the ONU3 1203, the value ABW3 is obtained as ABW3=TABW3=1875.

Subsequently, the final allocation band value ABWn is normalized to an integral multiple of the MTU traffic band BW_{MTU} to thereby correct the final allocation band value ABWn (step S110). In the operation, the remainder is added to ExBWn.

Therefore, for the ONU1 1201, ABW1 is calculated as ABW1=18750−(18750 mod 810)=18630. The carry-over band ExBW1 is attained as ExBW1=18750 mod 810=120.

In the case of ONU1 1202, ABW2 is calculated as ABW2=9375−(9375 mod 810)=8190, and ExBW2 is obtained as ExBW2=9375 mod 810=465.

Also, for the ONU1 1203, ABW3 is acquired as ABW3=1875−(1875 mod 810)=1620 and ExBW3 is attained as ExBW3=1875 mod 810=255.

Thereafter, the remaining band TBW is updated as follows.

First, BW_{MTU}×m, which was subtracted in step S103, is added to TBW.

That is, TBW=TBW+BW_{MTU}×m.

If TBW>BW_{MTU}, for the ONUn for which the allocation is not completed in step S107 and for which the carry-over band ExBWn is more than zero, the MTU traffic band BW_{MTU} is added to the final allocation band value ABWn (ABWn+BW_{MTU}). Simultaneously, the MTU traffic band BW_{MTU} is subtracted from the carry-over band ExBWn (ExBWn−BW_{MTU}).

In other words, the DBA scheduler 1210 calculates ABWn and ExBWn: ABWn=ABWn+BW_{MTU}; and ExBWn=ExBWn−BW_{MTU}.

Since n≧m, each time the MTU traffic band BW_{MTU} is added to the final allocation band value ABWn (ABWn+BW_{MTU}), the remaining band is updated: TBW=TBW−BW_{MTU}. The operation is repeatedly conducted until TBW is less than BW_{MTU} or until there does not exist any ONUn for which ExBWn>0 is satisfied.

Since TBW=0 in step S108 and m=0 in step S103, TBW is attained as TBW=0+810×0=0.

Since TBW is zero and is less than BW_{MTU}, the process goes to step S112 although ExBW1, EXBW2, and EXBW3 are more than zero.

Next, the DBA scheduler 1210 compares the final allocation band value ABWn, the queue length request value RBWn, and the MTU traffic band BW_{MTU} with each other to update the ABWn and the carry-over band ExWBn.

FIGS. 12 and 13 shows the processing in step S112.

For the ONU1 1201, ABW1 is 18630, RBW1 is 50000, and BW_{MTU} is 810.

Therefore, the following inequalities hold: RBW1 (50000)≧ABW1 (18630)≧BW_{MTU} (810). Hence the case of ONU1 1201 corresponds to condition 2 shown in FIG. 12.

Similarly, ABW2 is 8910, RBW1 is 50000, and BW_{MTU} is 810 for the ONU2 1202.

Consequently, the following inequalities hold: RBW2 (50000)≧ABW2 (8910)≧BW_{MTU} (810). Therefore, the case of ONU2 1202 corresponds to condition 2 of FIG. 12.

For the ONU3 1203, ABW3 is 1620, RBW3 is 50000, and BW_{MTU} is 810.

Therefore, the following inequalities hold: RBW3 (50000)≧ABW3 (1620)≧BW_{MTU} (810). The case of ONU3 1203 corresponds to condition 2 shown in FIG. 12.

Since the ONU1 1201 to ONU3 1203 correspond to condition 2 of FIG. 12, the value of ABWn is not updated. Therefore, the final allocation band value is determined as ABW1=18630 for the ONU1 1201, ABW2=8910 for the ONU2 1202, and ABW3=1620 for the ONU3 1203.

In the DBA algorithm 1211 of the embodiment, the remaining band TBW is distributed according to the ratio of the maximum band limit value MaxBWn (an SLA parameter). This hence makes it possible to achieve impartiality between the services even in the state of congestion.

For example, in the embodiment, the ratio of MaxBWn is represented as MaxBW1:MaxBW2:MaxBW3=30000:15000:3000=10:5:1.

The ratio of the dynamic allocation band value DBWn calculated using TBW is expressed as (ABW1−MinBW1+ExBW1):(ABW2−MinBW2+ExBW2):(ABW3−MinBW3+ExBW3)=(18630−3000+120):(8910−1500+465):(1620−300+255)=15750:7875:1575=10:5:1.

Therefore, since the dynamic allocation band value DBWn is distributed according to the ratio of the maximum band limit value MaxBWn, it is possible to guarantee impartiality between the services.

According to the DBA algorithm 1211 of the embodiment, the concept of the carry-over band ExBWn is introduced and a check is made in step S112 to determine whether the final allocation band value ABWn has reached the MTU traffic band BW_{MTU} required for the traffic of the frame having the MTU length. It is hence possible to avoid the disadvantage of the remaining of the long frame in the data buffer of the ONU (1201 to 1203).

In the DBA algorithm 1211 of the embodiment, when the system is in a state of digestion (in which ABWn is less than the queue length request value RBWn), ABWn is corrected to an integral multiple of the MTU traffic band BW_{MTU}. It is therefore possible to improve the line utilization efficiency for the short and long frames frequently employed in the actual traffic.

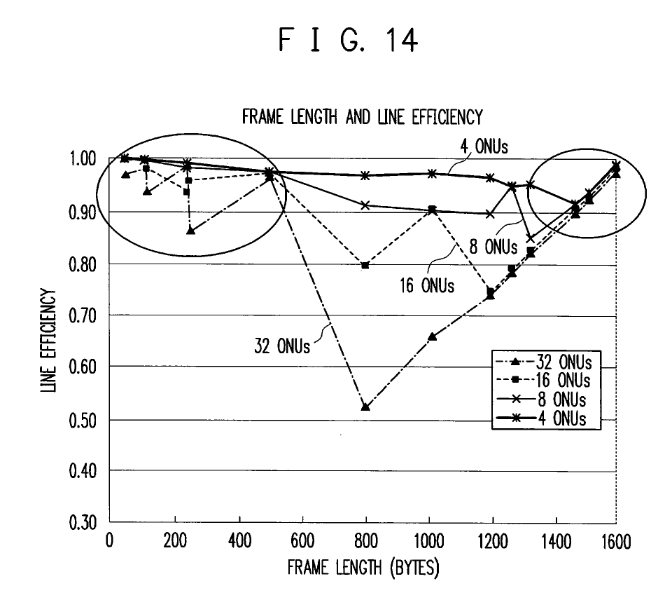

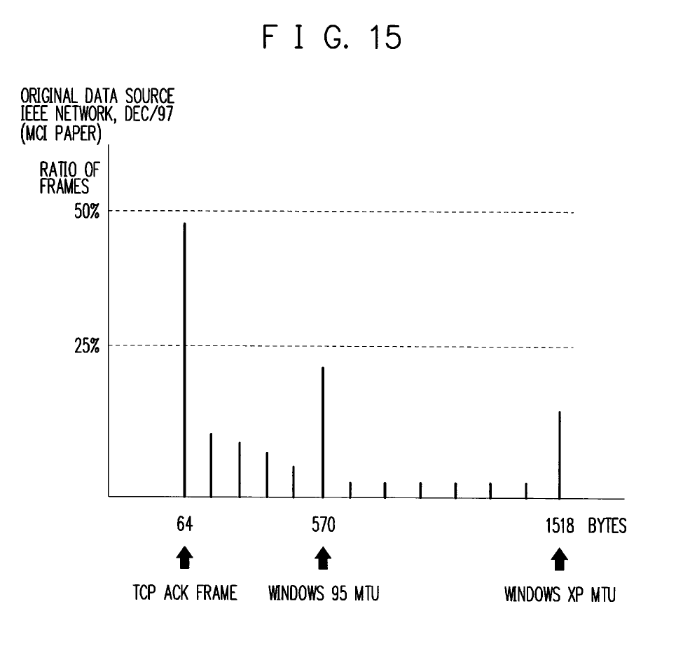

FIG. 14 shows a relationship between the line utilization efficiency and the frame lengths when the DBA algorithm 1211 of the embodiment is adopted. FIG. 15 shows an example of distribution of frame lengths in actual traffic. As can be seen from the graph of FIG. 15, the short and long frames are frequently used in the actual traffic. The line utilization efficiency is favorable for the short and long frames as shown in FIG. 14.

The embodiments described above are embodiments suitably implemented according to the present invention. However, the present invention is not restricted by the embodiments and it is possible to modify the embodiments in various ways within the scope and spirit of the present invention.

For example, the sequence of operations of processing of FIG. 10 executed according to the DBA algorithm 1211 shown in FIG. 10 may also be carried out by a computer program. The computer program may be recorded on an optical recording medium, a magnetic recording medium, an optomagnetic recording medium, or a recording medium of semiconductor such that the computer program is read therefrom to be loaded in an information processor for execution thereof. Also, the computer program may be acquired from an external device connected via a predetermined network to the information processor such that the information processor conducts the sequence of operations according to the DBA algorithm 1211.

The band allocation control apparatus, the band allocation control method, and the band allocation control program in accordance with the present embodiments are applicable to the GE-PON system.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A band allocation control apparatus for controlling bands to be allocated to a plurality of Optical Network Units (ONUs), comprising band allocating section for setting an allocation band to be allocated to each of the ONUs according to a ratio of maximum band limit values of the ONUs.

2. The band allocation control apparatus in accordance with claim 1, wherein:
the band allocating section sets an allocation band for a remaining band allocatable in the band allocation control apparatus according to the ratio of maximum band limit values, and
the band allocating section distributes the remaining band to the ONUs.

3. The band allocation control apparatus in accordance with claim 1, further comprising a control table for controlling the maximum band limit values of the ONUs, wherein the band allocating section sets the allocation band to be allocated to each of the ONUs according to the ratio of the maximum band limit values controlled by the control table.

4. The band allocation control apparatus in accordance with claim 1, further comprising:
queue length request value acquiring section for acquiring a queue length request value of an ONU;
collected fixed band value calculating section for calculating a collected fixed band value according to the queue length request value; and
remaining band calculating section for calculating a remaining band allocatable in the band allocation control apparatus, according to the collected fixed band value, wherein
the band allocating section sets an allocation band for the remaining band allocated to the ONUs according to the ratio of maximum band limit values.

5. The band allocation control apparatus in accordance with claim 1, wherein a maximum band limit value is one of Service Level Agreement (SLA) parameters set for each of the ONUs.

6. The band allocation control apparatus in accordance with claim 4, further comprising:
determining section for determining whether the allocation band allocated by the band allocating section is less than the queue length request value and the allocation band has reached a Maximum Transmission Unit (MTU) traffic band required for traffic to pass a frame having an MTU length; and
allocation band changing section for changing the allocation band to a fixed band value of an ONU if the determining section determines that the allocation band is less than the queue length request value and has reached the MTU traffic band.

7. The band allocation control apparatus in accordance with claim 6, further comprising allocation band correcting section for correcting the allocation band allocated by the band allocating section to be an integral multiple of the MTU traffic band.

8. The band allocation control apparatus in accordance with claim 7, wherein the allocation band correcting section corrects, if the allocation band allocated by the band allocating section is less than the queue length request value, the allocation band to be an integral multiple of the MTU traffic band.

9. A band allocation control method for use with a band allocation control apparatus for controlling bands to be allocated to a plurality of ONUs, comprising the band allocating step for setting an allocation band to be allocated to each of the ONUs according to a ratio of maximum band limit values of the ONUs.

10. The band allocation control method in accordance with claim 9, wherein the band allocating step comprises:
setting an allocation band for a remaining band allocatable in the band allocation control apparatus according to the ratio of maximum band limit values, and
distributing the remaining band to the ONUs.

11. The band allocation control method in accordance with claim 9, wherein:
the band allocation control apparatus comprises a control table for controlling for each of the ONUs the maximum band limit values of the ONUs; and
the band allocating step comprises setting the allocation band to be allocated to each of the ONUs according to the ratio of the maximum band limit values controlled by the control table.

12. The band allocation control method in accordance with claim 9, further comprising:
the queue length request value acquiring step of acquiring a queue length request value of an ONU;
the collected fixed band value calculating step of calculating a collected fixed band value according to the queue length request value; and
the remaining band calculating step of calculating a remaining band allocatable in the band allocation control apparatus, according to the collected fixed band value, wherein the band allocating step comprises setting an allocation band for the remaining band allocated to the ONUs according to the ratio of maximum band limit values.

13. The band allocation control method in accordance with claim 9, wherein a maximum band limit value is one of SLA parameters set for each of the ONUs.

14. The band allocation control method in accordance with claim 12, further comprising:
the determining step of determining whether the allocation band allocated by the band allocating step is less than the queue length request value and the allocation band has reached an MTU traffic band required for traffic to pass a frame having an MTU length; and
the allocation band changing step of changing the allocation band to a fixed band value of an ONU if the determining step determines that the allocation band is less than the queue length request value and has reached the MTU traffic band.

15. The band allocation control method in accordance with claim 14, further comprising the allocation band correcting step of correcting the allocation band allocated by the band allocating step to be an integral multiple of the MTU traffic band.

16. The band allocation control method in accordance with claim 15, wherein the allocation band correcting step comprises correcting, if the allocation band allocated by the band allocating step is less than the queue length request value, the allocation band to be an integral multiple of the MTU traffic band.

17. A computer program product embodied on a computer-readable medium and comprising code that, when executed, causes a computer to perform the following: band allocating processing for setting an allocation band for each of the ONUs based on a ratio of maximum band limit values of the ONUs.

18. The computer program product in accordance with claim 17, wherein:
the band allocating processing sets an allocation band for a remaining band allocatable in a band allocation control apparatus according to the ratio of maximum band limit values, and
the band allocating processing distributes the remaining band to the ONUs.

19. The computer program product in accordance with claim 17, wherein:
the band allocating processing sets the allocation band to be allocated to each of the ONUs, according to the ratio of the maximum band limit values controlled by a control table.

20. The computer program product in accordance with claim 17, further comprising:
queue length request value acquiring processing for acquiring a queue length request value of an ONU;
collected fixed band value calculating processing for calculating a collected fixed band value according to the queue length request value; and
remaining band calculating processing for calculating a remaining band allocatable in a band allocation control apparatus, according to the collected fixed band value, wherein
the band allocating processing sets an allocation band for the remaining band allocated to the ONUs according to the ratio of maximum band limit values.

21. The computer program product in accordance with claim 17, wherein a maximum band limit value is one of SLA parameters set for each of the ONUs.

22. The computer program product in accordance with claim 20, further comprising:
determining processing for determining whether the allocation band allocated by the band allocating processing is less than the queue length request value and the allocation band has reached an MTU traffic band required for traffic to pass a frame having an MTU length; and
allocation band changing processing for changing the allocation band to a fixed band value of an ONU if the determining processing determines that the allocation band is less than the queue length request value and has reached the MTU traffic band.

23. The computer program product in accordance with claim 22, further comprising allocation band correcting processing for correcting the allocation band allocated by the band allocating processing to be an integral multiple of the MTU traffic band.

24. The computer program product in accordance with claim 23, wherein the allocation band correcting processing corrects, if the allocation band allocated by the band allocating processing is less than the queue length request value, the allocation band to be an integral multiple of the MTU traffic band.
